(19) United States
(12) Patent Application Publication
(10) Pub. No.: US 2025/0342983 A1
(43) Pub. Date: Nov. 6, 2025

(54) FUSIBLE FLEXIBLE BUSBAR

(71) Applicant: Manaflex, LLC, Waikoloa, HI (US)

(72) Inventors: Robert C. LANE, Las Vegas, NV (US); Augusto E. BARTON, Pinecrest, FL (US); Yifei LIU, Toronto (CA)

(21) Appl. No.: 19/197,264

(22) Filed: May 2, 2025

Related U.S. Application Data
(60) Provisional application No. 63/642,847, filed on May 5, 2024.

(51) Int. Cl. H01B 5/00; H01H 85/02

(52) U.S. Cl. CPC H01B 5/002; H01H 85/0241

(57) ABSTRACT

A flexible conductive busbar with a fuse, comprising several layers of stacked conductive buses and conductive connection layers set between adjacent conductive buses. The conductive bus includes two spaced connection buses and a fuse connected between the two connection buses. The conductive connection layer includes two connection pieces respectively set between the corresponding connection buses.

### CROSS-REFERENCE TO RELATED APPLICATION

This application is a non-provisional application of, and claims priority to and the benefit of, U.S. Provisional Patent App. No. 63/642,847, entitled “Fusible Flexible Busbar”, filed May 5, 2024, with Attorney Docket No. 4375.0019P, the entire disclosure of which is incorporated by reference herein in its entirety.

### FIELD OF INVENTION

The present invention relates to the field of new energy battery technology, and particularly to a flexible conductive busbar with a fuse.

### BACKGROUND

To alleviate the impact of battery expansion force on the connection of busbars, the thickness of busbars on the market is generally thick to ensure strength and prevent the battery expansion force from breaking the busbars. These busbars are usually formed by one-time stamping, and the stamped busbars are manually assembled into finished CCS (Cells Contact System), which is also known as an integrated busbar or a wiring harness board assembly, battery cover assembly, etc., for production. The material cost of stamped busbars is high, and the corresponding production cost is also high. Moreover, it is difficult to achieve fully automated assembly line production, resulting in low production efficiency. Therefore, improvements are needed.

### SUMMARY

The purpose of the present invention is to provide a flexible conductive busbar with a fuse to overcome the shortcomings of the prior art.

To achieve the above object, the present invention provides the following technical solutions.

The present invention discloses a flexible conductive busbar with a fuse, comprising multiple layers of stacked conductive busbars and a conductive connection layer set between adjacent conductive busbars. The conductive busbars comprise two spaced-apart connection bars and fuses connected between the two connection bars. The conductive connection layer comprises two connection pieces respectively set between corresponding connection bars.

Furthermore, in the flexible conductive busbar with a fuse as described above, the fuses between adjacent conductive busbars are arranged alternately.

Furthermore, in the flexible conductive busbar with a fuse as described above, the fuses between adjacent conductive busbars may have the same or different specifications.

Furthermore, in the flexible conductive busbar with a fuse as described above, the surface of the fuses is coated with insulating material.

Furthermore, in the flexible conductive busbar with a fuse as described above, the side end of the connection piece near the fuse does not protrude beyond the end face of the corresponding connection bar.

Furthermore, in the flexible conductive busbar with a fuse as described above, the fuses are integrally formed with the corresponding connection bars.

Furthermore, in the flexible conductive busbar with a fuse as described above, the fuses are separately arranged with the corresponding connection bars, and both ends of the fuses are electrically connected to the corresponding connection bars.

Compared with conventional systems, the advantages of the present invention are as follows: the structure of the present invention is formed by stacking multiple layers of conductive busbars and conductive connection layers. The connection bars and fuses can be produced on assembly lines using coil materials and fully automatic circular knife/laser cutting machines, and subsequent processes such as insulation coating can be performed automatically, saving labor costs and increasing production efficiency. The fuses are not only used for electrical connection between connection bars to ensure the conductivity of the flexible conductive busbar but also fuse timely when subjected to abnormally high currents, improving safety performance. Additionally, the fuses can mitigate vibrations and absorb stretching caused by battery expansion, enhancing the stability and lifespan of the flexible conductive busbar.

### BRIEF DESCRIPTION OF THE DRAWINGS

To better illustrate the embodiments of the present invention, the following will provide a brief introduction to the drawings required in the embodiments. Obviously, the drawings described below are only some embodiments recorded in the present invention. Ordinary skilled persons in the field can obtain other drawings based on these drawings without exerting creative labor.

FIG. 1 shows a schematic diagram of the structure of a specific embodiment of the flexible conductive busbar with a fuse in the present invention.

FIG. 2 shows an enlarged schematic diagram of area I in FIG. 1.

FIG. 3 shows a schematic diagram of the structure of the flexible conductive busbar with a fuse in a specific embodiment of the present invention, with the outer conductive busbars omitted.

FIG. 4 shows an enlarged schematic diagram of area II in FIG. 3.

FIG. 5 shows a perspective view of an alternative embodiment of a multi-layer flexible busbar with fusible elements according to the present invention.

FIG. 6 shows portion of an alternative embodiment of a fuse type according to the present invention.

FIG. 7 shows portion of an alternative embodiment of a fuse type according to the present invention.

FIG. 8 shows portion of an alternative embodiment of a fuse type according to the present invention.

Like reference numerals have been used to identify like elements throughout this disclosure.

### DETAILED DESCRIPTION

The following will describe in detail the technical solutions in the embodiments of the present invention with reference to the accompanying drawings. It should be noted that the described embodiments are only part of the embodiments of the present invention, not all embodiments. Based on the embodiments of the present invention, all other embodiments obtained by ordinary skilled persons in the field without creative labor are within the scope of protection of the present invention.

In the description of the present invention, it should be noted that the terms “center,” “upper,” “lower,” “left,” “right,” “vertical,” “horizontal,” “inner,” “outer,” etc., indicating directions or positional relationships, are based on the orientation or positional relationship shown in the drawings. It is only for facilitating the description of the present invention and simplifying the description, rather than indicating or implying that the device or component referred to must have a specific orientation or be constructed and operated in a specific orientation, and thus should not be construed as limiting the present invention. In addition, terms such as “first,” “second,” “third” are used for descriptive purposes only and should not be construed as indicating or implying relative importance.

In the description of the present invention, it should be noted that unless otherwise specified and limited, terms such as “installation,” “connection,” “linking” should be broadly interpreted. For example, it can be fixed connection, detachable connection, or integral connection; it can be mechanical connection or electrical connection; it can be direct connection or indirect connection through intermediate media; it can be internal connection between two components. For ordinary skilled persons in the field, the specific meanings of the above terms in the present invention can be understood according to specific circumstances.

The present invention discloses a flexible conductive busbar with a fuse, comprising several layers of stacked conductive buses and conductive connection layers set between adjacent conductive buses. The conductive bus includes two spaced connection buses and a fuse connected between the two connection buses. The conductive connection layer includes two connection pieces respectively set between the corresponding connection buses.

The structure of the present invention includes connection buses and fuses that can be mass-produced using coil material and fully automatic rotary blade/laser cutting machines, and subsequent processes such as attaching insulation layers can be fully automated, saving labor costs and increasing production efficiency. The fuse is not only used for electrical connection between the connection buses to ensure the conductivity of the flexible conductive busbar but also melts in case of abnormal high current flow, thereby improving safety performance. Additionally, the fuse can also alleviate vibration and absorb stretching caused by battery expansion, thereby improving the stability and lifespan of the flexible conductive busbar

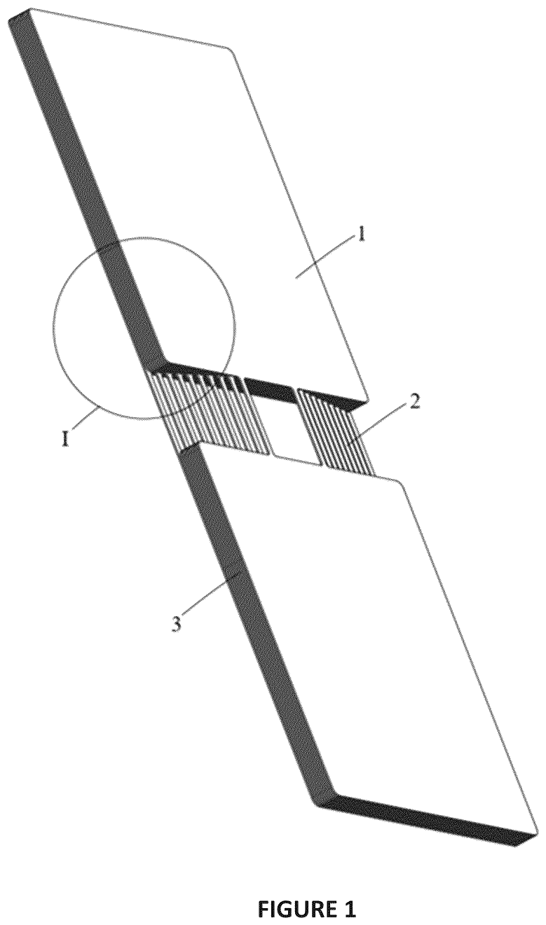

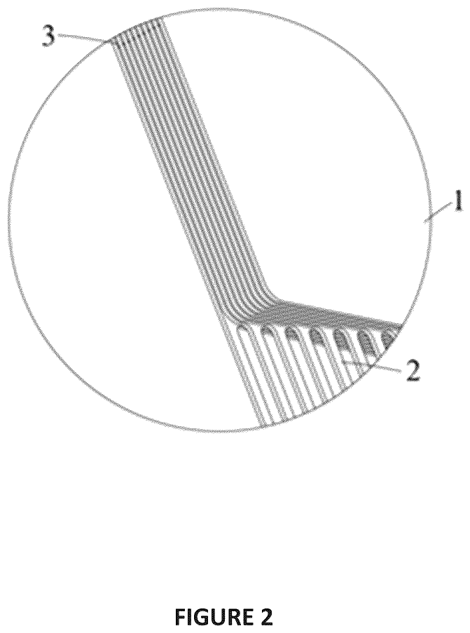

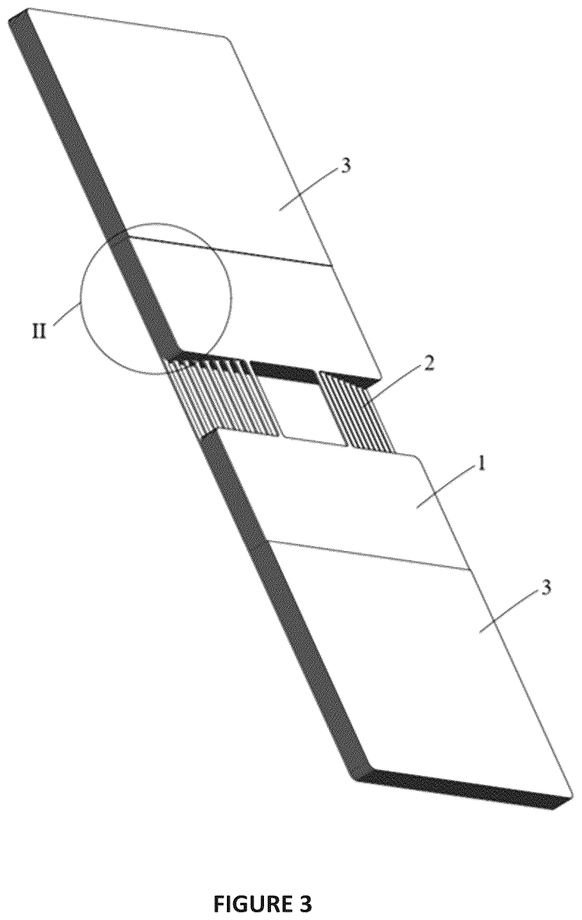

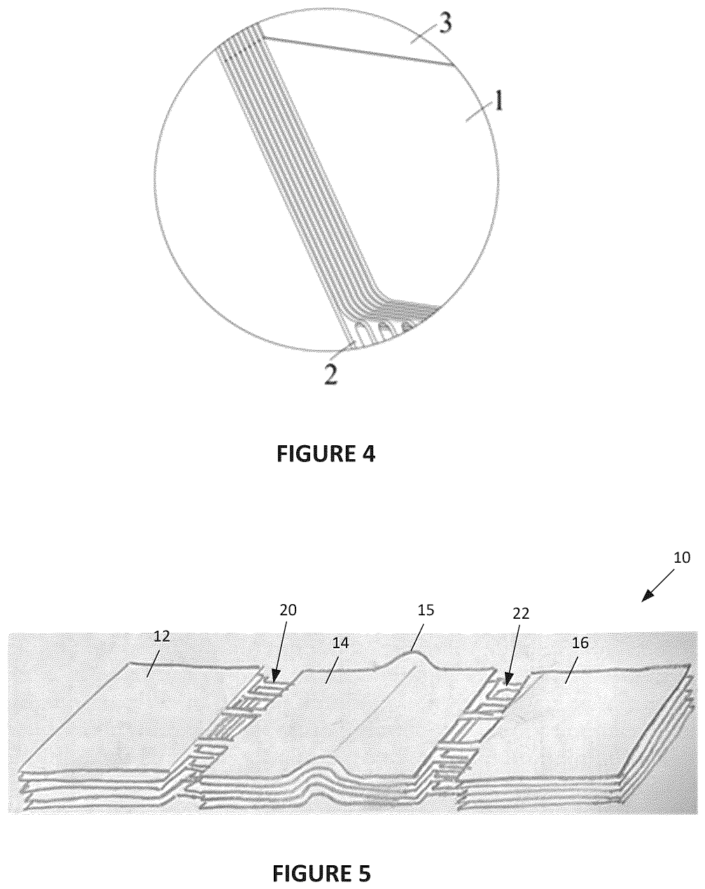

Exemplarily, as shown in FIGS. 1 to 4, a flexible conductive busbar with a fuse includes multiple layers of conductive busbars and conductive connection layers set between adjacent conductive busbars. The conductive busbars include two spaced-apart connection bars 1 and fuses 2 connected between the two connection bars 1. The conductive connection layer includes two pieces of connection pieces 3 set between corresponding connection bars 1.

In this technical solution, the connection bars are used to connect the positive or negative poles of the battery and are provided with positioning holes corresponding to the battery (not shown). In actual applications, to reduce the weight of the product and production costs, both the connection bars and fuses are made of conductive materials, including but not limited to aluminum, copper, steel, nickel, as well as composite materials and various alloys. The connection pieces are conductive soldering materials. After the conductive busbars and the conductive connection layers are stacked, multiple layers of connection bars and corresponding connection pieces are rigidly connected as a whole by welding or other methods to meet the strength requirements. The connection bars and fuses can be produced using roll materials and fully automatic circular blade/laser cutting machines, and subsequent processes such as attaching insulation layers can be fully automated, saving labor costs and increasing production efficiency. The fuses can be of any shape, such as linear or wavy. In this technical solution, during the high-current fuse breaking process, the fuse wire often generates electric sparks, which can damage surrounding electrical appliances. To enhance safety during use, the fuse wire is coated with insulating materials such as insulating gel. Additionally, to facilitate processing, the gaps between the connection bars are filled with injection-molded or over molded insulating and flame-retardant sealing agents or potting compounds to encapsulate the fuse wire, preventing the occurrence of electric sparks. This process also provides physical support, preventing deformation or breakage of the fuse wire during production, installation, and use. Exemplarily, as shown in FIGS. 1 to 4, the fuses 2 between adjacent conductive busbars are staggered.

In this technical solution, the fuses of the stacked conductive busbars are staggered to improve the stability of the connection between the connection bars on both sides of the fuses and reduce the possibility of interference between adjacent fuses.

Exemplarily, as shown in FIGS. 1 to 4, the fuses 2 between adjacent conductive busbars may have the same or different specifications.

In this technical solution, the total melting current of the flexible conductive busbar is equal to the sum of the melting currents of the fuses of each layer. By setting the specifications of the fuses of each layer to be the same or different, the total melting current can be adjusted. When an excessively high current occurs, after the fuses with smaller melting currents in one part are melted, the excessive current will generate higher heat on the unfused parts of the fuses, prompting them to melt more quickly.

Exemplarily, the surface of the fuses 2 may be coated with insulating material (not shown).

In this technical solution, during the large current melting process, the fuses often generate electric sparks, which may damage surrounding electrical appliances. To improve safety of use, the surface of the fuses is coated with insulating materials such as insulating glue. To facilitate processing, the gaps between the connection bar are sealed with sealant to wrap the fuses, preventing electric sparks and providing physical support to prevent deformation or breakage of the fuses during production, installation, and use.

Exemplarily, as shown in FIGS. 1 to 4, the connection pieces 3 do not protrude from the corresponding ends of the connection bars 1 near the fuses 2.

In this technical solution, the length of the connection pieces along the length of the fuses is less than the length of the corresponding connection bars. After stacking, the connection pieces are spaced from the corresponding ends of the fuses, avoiding contact between the connection pieces and the fuses, which may cause abnormal melting current of the fuses.

Exemplarily, as shown in FIGS. 1 to 4, the fuses 2 are integrally formed with the corresponding connection bars 1.

In this technical solution, the fuses and the corresponding connection bars in the same layer are integrally formed, and roll materials and fully automatic circular blade/laser cutting machines are used for production on the assembly line. Subsequent processes such as attaching insulation layers can be fully automated, saving labor costs and increasing production efficiency.

Exemplarily, the fuses 2 are separately arranged from the corresponding connection bars 1, and their two ends are electrically connected to the corresponding connection bars 1, respectively.

In this technical solution, the fuses are processed separately from the corresponding connection bars by laser cutting machines or other means. The two ends of the fuses are electrically connected to the corresponding connection bars by welding or other methods, and then the welded conductive busbars are stacked as a whole.

In summary, the present invention has a structure that is formed by stacking multiple layers of conductive busbars and conductive connection layers. The connection bars and fuses can be produced using roll materials and fully automatic circular blade/laser cutting machines, and subsequent processes such as attaching insulation layers can be fully automated, saving labor costs and increasing production efficiency. The fuses are not only used for electrical connection between the connection bars to ensure the conductivity of the flexible conductive busbar, but also can melt timely when an abnormally high current passes through, improving the safety performance of use. Additionally, the fuses can alleviate vibration and absorb the tensile force generated by the expansion of the battery, improving the stability and service life of the flexible conductive busbar.

In various embodiments, the busbar can be made of any electrically conducting material, including but not limited to, aluminum, copper, nickel, steel, and composite materials. In addition, the various layers can be made of the same or different material types.

In other embodiments, the fuses can be encapsulated. The encapsulant may have one or more of the following properties: fireproof, dielectric, doesn't degrade to a conductive by product, and/or is phase changing.

Referring to FIG. 5, a perspective view of a multi-layer flexible busbar with fusible elements is illustrated. The multi-layer flexible busbar 10 has several sections 12, 14, and 16, with the middle section 14 being the element or section used specifically for flexing as shown in FIG. 5. The multi-layer flexible busbar 10 also has several fusible elements 20 located between sections 12 and 14, and several other fusible elements 22 located between sections 14 and 16. The fusible elements 20 and 22 are in two separate areas along the length of the busbar 10. This embodiment alleviates the fusible elements 20 and 22 from being the portion of the busbar 10 that flexes, which would potentially compromise their durability. Accordingly, this embodiment separates the two functions, and can work as intended by using the proper mechanical constraints.

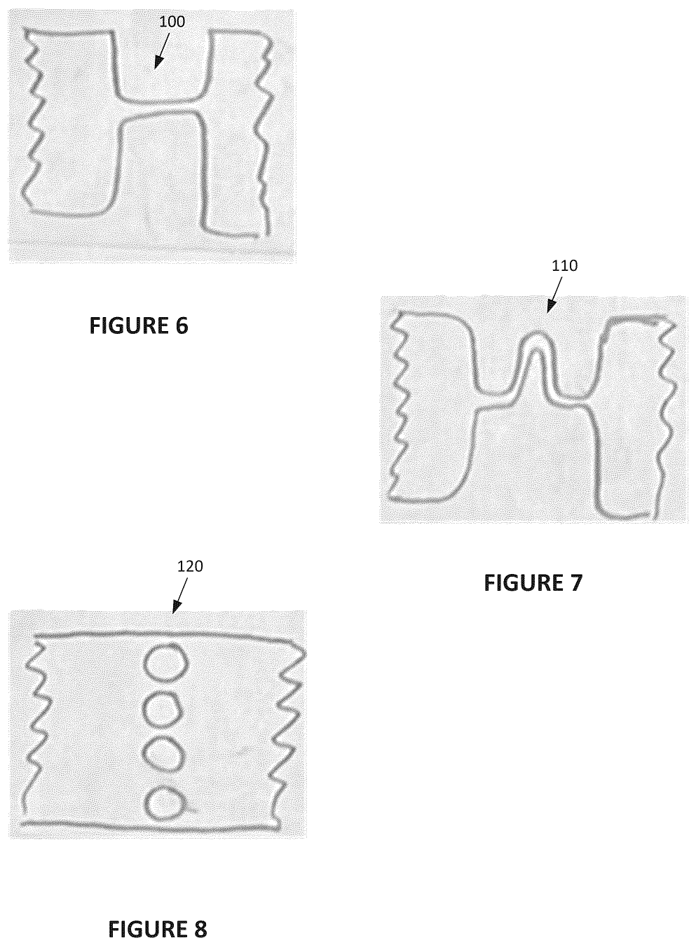

Referring to FIGS. 6-8, different embodiments and types of fuses that can be included in the fusible flexible busbar disclosed herein are illustrated. In FIG. 6, one type of fuse 100 is illustrated. In FIG. 7, another type of fuse 110 is illustrated. In FIG. 8, another type of fuse 120 is illustrated. In other embodiments, additional shapes of fuses can be used.

It should be noted that, in this document, the terms “including,” “comprising” or any other variant thereof are intended to encompass non-exclusive inclusion, such that a process, method, item or device comprising a series of elements not only includes those elements but also includes other elements not explicitly listed, or even includes elements inherent to such process, method, item, or device. In the absence of further limitations, the elements limited by the statement “including a . . . ” are not excluded from the process, method, item or device comprising the elements, and other identical elements may exist in the process, method, item or device comprising the elements.

The above-described embodiments are only specific embodiments of the present invention. It should be pointed out that for ordinary skilled persons in the technical field, various improvements and modifications can be made without departing from the principles of the present invention, and these improvements and modifications should also be considered within the scope of the present invention.

What is claimed is:

1. A flexible conductive busbar with a fuse, comprising:
several layers of stacked conductive buses; and
conductive connection layers set between adjacent conductive buses, wherein each of the conductive buses includes two spaced connection buses and a fuse connected between the two spaced connection buses, and each of the conductive connection layers includes two pieces set between corresponding connection buses.

2. The flexible conductive busbar with a fuse according to claim 1, wherein fuses between adjacent conductive buses are arranged alternately.

3. The flexible conductive busbar with a fuse according to claim 1, wherein fuses between adjacent conductive buses have same or different specifications.

4. The flexible conductive busbar with a fuse according to claim 1, wherein a surface of the fuse is wrapped with insulation material.

5. The flexible conductive busbar with a fuse according to claim 1, wherein the connection piece does not protrude from a side end face near the fuse compared to an end face of the corresponding connection bus.

6. The flexible conductive busbar with a fuse according to claim 1, wherein the fuse is integrally formed with the corresponding connection bus.

7. The flexible conductive busbar with a fuse according to claim 1, wherein the fuse is separately arranged with the corresponding connection bus, and both ends of the fuse are electrically connected to the corresponding connection buses.

8. The flexible conductive busbar with a fuse according to claim 2, wherein the fuse is integrally formed with the corresponding connection bus.

9. The flexible conductive busbar with a fuse according to claim 3, wherein the fuse is integrally formed with the corresponding connection bus.

10. The flexible conductive busbar with a fuse according to claim 4, wherein the fuse is integrally formed with the corresponding connection bus.

11. The flexible conductive busbar with a fuse according to claim 5, wherein the fuse is integrally formed with the corresponding connection bus.

12. The flexible conductive busbar with a fuse according to claim 2, wherein the fuse is separately arranged with the corresponding connection bus, and both ends of the fuse are electrically connected to the corresponding connection buses.

13. The flexible conductive busbar with a fuse according to claim 3, wherein the fuse is separately arranged with the corresponding connection bus, and both ends of the fuse are electrically connected to the corresponding connection buses.

14. The flexible conductive busbar with a fuse according to claim 4, wherein the fuse is separately arranged with the corresponding connection bus, and both ends of the fuse are electrically connected to the corresponding connection buses.

15. The flexible conductive busbar with a fuse according to claim 5, wherein the fuse is separately arranged with the corresponding connection bus, and both ends of the fuse are electrically connected to the corresponding connection buses.
